(19) United States
(12) Patent Application Publication
(10) Pub. No.: US 2009/0019192 A1
(43) Pub. Date: Jan. 15, 2009

(54) USB TRANSMISSION SYSTEM AND RELATED METHOD FOR ACCESSING DATA IN A FIRST USB SPECIFICATION WITH A SPEED OF A SECOND USB SPECIFICATION

(75) Inventor: Yuan-Shuen Yeh, Shijr City (TW)

Correspondence Address: MADSON & AUSTIN, 15 WEST SOUTH TEMPLE, SUITE 900, SALT LAKE CITY, UT, 84101, US

(73) Assignee: Aten International Co., Ltd., Shijr City (TW)

(21) Appl. No.: 11/775,065

(22) Filed: Jul. 9, 2007

(51) Int. Cl. G06F 3/01

(52) U.S. Cl. 710/52

(57) ABSTRACT

A USB transmission system includes a transferring device for outputting connecting packet when the transferring device is electrically connected to a USB storage device for storing data in a first USB specification, and a server for receiving the connecting packet and accordingly outputting a request packet to the transferring device. The transferring device receives the request packet and accordingly outputs a first response packet in indicative of a second USB specification to the server. The first response packet indicates a device descriptor, and a configuration descriptor, of which the USB version defined in the device descriptor is set as the second USB specification, and the maximum packet size defined in the configuration descriptor is set as the speed of the second USB specification. The first USB specification complies with USB 1.1 specification, while the second USB specification complies with USB 2.0 specification.

### BACKGROUND OF THE INVENTION

1. Field of the Invention

The present invention relates to a Universal Serial Bus (USB) transmission system and related method, more particularly to a USB transmission system and related method for accessing data in a first USB specification with a speed of a second USB specification.

2. Description of the Related Art

With a rapid development of data transmission technology, Universal Serial Bus (USB) specification was to provide a rapid and economical method for connecting various peripheries with personal computers, and has become a main interface for digital cameras, printers, scanners, mice, joysticks, speakers, video phones and CD burners. The Universal Serial Bus divides the available bandwidth into frames and the host controls the frames. For USB 1.1 frames contain 1,500 bytes (12,000 bits) and a new frame starts every millisecond. During a one second interval of time, 12 megabits of data may be transmitted. The standard for USB 2.0 specification was released in 2000 year and serves as an upgrade for USB 1.1 specification. USB 2.0 provides additional bandwidth for multimedia and storage applications. To allow a smooth transition for both consumers and manufacturers, USB 2.0 has full forward and backward compatibility with original USB devices and works with cables and connectors made for earlier versions of USB. For USB 2.0 specification, during a one second interval of time, 480 megabits of data may be transmitted. In sum, the USB 1.1 specification defines a maximum data rate of 12 megabits per second, i.e. full-speed mode of 12 Mbps, and a USB 2.0 specification has a maximum data rate of 480 megabits per second, i.e. high speed mode of 480 Mbps. The transmission speed of USB 2.0 facilitates the development of next-generation PCs and applications. Additionally, USB 2.0 increases the productivity of user applications and allows the user to run multiple PC applications at once or several high-performance peripherals simultaneously. So far, almost all peripheral devices now come in a USB specification.

As a demand for a faster data transfer has been recently increased, for the USB 2.0 specification can transfer data faster than full Speed defined in USB 1.1 specification, the use of electrical peripheral devices that are compatible with high speed mode defined in USB 2.0 specification is a trend.

For a high-speed external peripheral devices that require great bandwidth, the USB interface will adopt the full-speed mode of 12 Mbps for the transmission, on the other hand, for a high-speed external device, the USB interface will adopt the high-speed mode of 480 Mbps for the transmission. The USB interface can automatically detect and switch between the high speed mode and the full speed mode dynamically according to the external peripheral devices electrically connected thereto. However, as for the high speed and the full speed defined in the USB 1.1 specification or the USB 2.0 specification, for example, if a storage device using USB 1.1 specification and a host is not exactly made to conform to the USB 1.1 specification, the data could not sometimes be transferred properly even if the transmitted data waveform is complied with the standard. To avoid such problem, despite a theoretical value of the data transfer rate of the high Speed is 480 Mbps, the data transfer between the host and the storage device is typically lowered to the full speed of 12 Mbps. Therefore, the data transfer rate is low but inefficient for the host using USB 2.0 specification.

### SUMMARY OF THE INVENTION

It is therefore a primary objective of this invention to provide a Universal Serial Bus (USB) transmission system and a related method for accessing data in a first USB specification with a speed of a second USB specification.

Briefly summarized, the claimed invention provides a Universal Serial Bus (USB) transmission system. The USB transmission system comprises a transferring device for outputting connecting packet when the transferring device is electrically connected to a USB storage device for storing data in a first USB specification, and a server for receiving the connecting packet and accordingly outputting a request packet to the transferring device. The transferring device receives the request packet and accordingly outputs a first response packet in indicative of a second USB specification to the server.

In one aspect of the present invention, the first USB specification complies with USB 1.1 specification, while the second USB specification complies with USB 2.0 specification.

In another aspect of the present invention, the server outputs a command packet to the transferring device, and the transferring device outputs a second response packet to the server in response to the command packet. And, then, the server accesses data in the USB storage device with the speed of the second USB specification.

In yet another aspect of the present invention, the server communicates with the transferring device via a network, which is selected from a group consisting of a Local area network, and an 802.11 series wireless network.

In still another aspect of the present invention, the first response packet indicates a device descriptor, and a configuration descriptor, of which the USB version defined in the device descriptor is set as the second USB specification, and the maximum packet size defined in the configuration descriptor is set as the speed of the second USB specification.

According to the claimed invention, a method of transmitting data between a server and a Universal Serial Bus (USB) storage device storing data in a first USB specification via a transferring device is provided. The method comprises the steps of outputting a connecting packet to the server by the transferring device when the USB storage device is electrically connected to the transferring device, outputting a request packet to the transferring device by the server when the server receives the connecting packet, and outputting a first response packet in indicative of a second USB specification to the server by the transferring device when the transferring device receives the request packet.

In one aspect of the invention, a method of transmitting data between a server and a Universal Serial Bus (USB) storage device storing data in a first USB specification via a computer with a transferring device is provided. The method comprises the steps of detecting the USB storage device of a first USB specification by the computer when the USB storage device is plugged in the computer; driving Virtual USB Storage function by the transferring device, and then detecting Virtual USB storage by the server; requesting the computer what kind of Virtual USB storage is by the server; modifying the contents of configuration descriptor and device descriptor from the first USB specification to a second USB specification; and changing the access speed of Virtual Storage between the server and the computer to the second USB specification.

In one aspect of the present invention, the method further comprises the steps of outputting a command packet to the transferring device by the server, outputting a second response packet to the server by the transferring device when the transferring device receives the command packet, and using speed of the second USB specification to access data in the USB storage device by the server.

In further aspect of the present invention, the first USB specification complies with USB 1.1 specification, while the second USB specification complies with USB 2.0 specification.

In another aspect of the present invention, the server outputs a command packet to the transferring device, and the transferring device outputs a second response packet to the server in response to the command packet. And, then, the server accesses data in the USB storage device with the speed of the second USB specification.

In yet another aspect of the present invention, the server communicates with the transferring device via a network, which is selected from a group consisting of a Local area network, and an 802.11 series wireless network.

In still another aspect of the present invention, the first response packet indicates a device descriptor, and a configuration descriptor, of which the USB version defined in the device descriptor is set as the second USB specification, and the maximum packet size defined in the configuration descriptor is set as the speed of the second USB specification.

The disclosed inventions will be described with reference to the accompanying drawings, which show important sample embodiments of the invention and which are incorporated in the specification hereof by reference.

### BRIEF DESCRIPTION OF THE DRAWINGS

FIG. 1 is a diagram of a Universal Serial Bus (USB) transmission system in accordance with the present invention.

FIG. 2 is a flowchart of transmitting data between the server and a Universal Serial Bus storage device via a transferring device.

### DETAILED DESCRIPTION OF THE PREFERRED EMBODIMENT

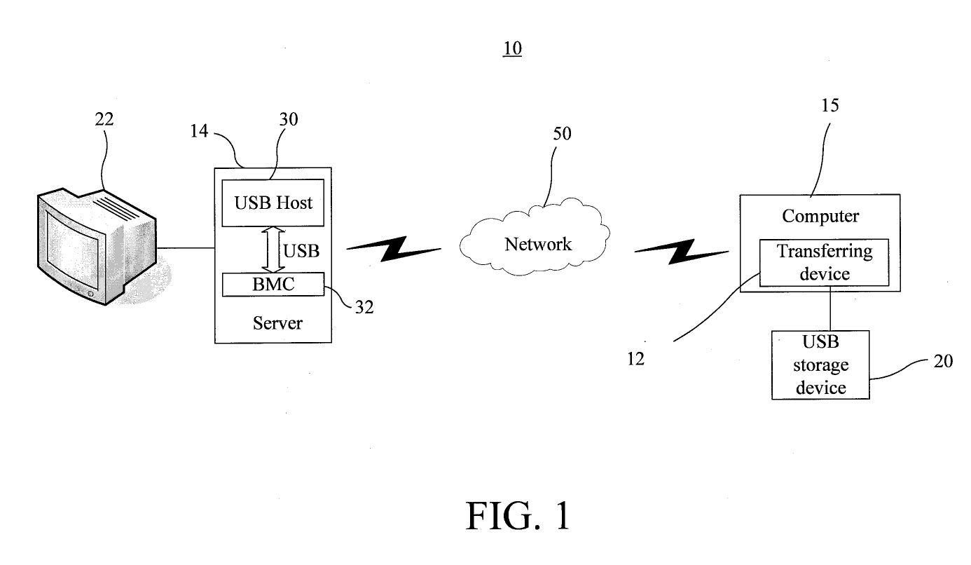

Referring to FIG. 1, as shown is a diagram of a Universal Serial Bus (USB) transmission system 10 in accordance with the present invention. The USB transmission system 10 comprises at least a computer 15 having a transferring device 12, a server 14, a USB storage device 20. The USB storage device 20 for storing data in a first USB specification complies with a first USB specification e.g. USB 1.1. The computer 15 may be a personal computer, a notebook computer, and a personal digital assistant. The server 14 comprises a USB host 30 and a baseboard management controller (BMC) 32. The USB host 30 comprises a host controller and a root-hub where the host controller may be implemented in a combination of hardware, firmware, or software, which is capable of controlling the data transmission over the USB system, and the root hub is integrated within the host by connecting to the host controller to provide one or more attachment points. The monitoring and controlling functions of the server 14 are provided through the use of a baseboard management controller (BMC). The server 14 communicates with the transferring device 12 via a network 50, which is selected from a group consisting of a Local area network(LAN), Wide area network(WAN), Internet, Ethernet, and an 802.11 series wireless network. A monitor 22 connecting to the server 14 is used for monitoring the operation of the transferring device 12 and the access to the USB storage device 20. Therefore, a user is capable of maintaining tighter security over their transferring devices (i.e. computers) and also simplifies the transferring devices' maintenance by locating them in a single place.

There is only one USB host in any USB system. The USB storage device 20 has to report its attributes and operations. Data transaction between USBs realized by packets of data transfer and is represented as report of data transfer. And the descriptor is used for illustrating the usage of the report.

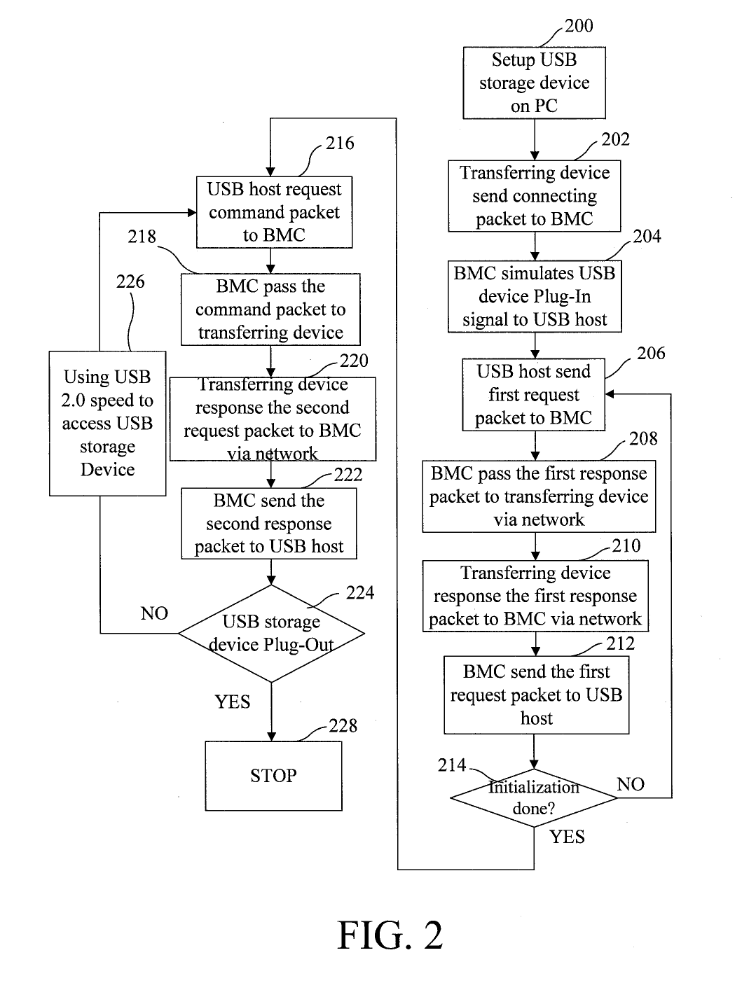

Please refer to FIG. 2 in conjunction with FIG. 1. FIG. 2 is a flowchart of transmitting data between the server and a Universal Serial Bus (USB) storage device via a transferring device.

### The Method Comprises the Steps of:

Step 200: Setup USB storage device 20 of a first USB specification (such as USB 1.1) on the transferring device 12. In step 200, the USB storage device 20 of a first USB specification is plugged in the computer 15, and then the computer 15 detects the USB storage device 20.
Step 202: The transferring device 12 sends a connecting packet to the BMC 32 of the server 14.
Step 204: The BMC 30 simulates USB storage device 20 plugging-in signal to the USB host 30. In steps 202˜204, the transferring device drives Virtual USB Storage function, and then the server detects Virtual USB storage.
Step 206: The USB host 30 sends a request packet to the BMC 32.
Step 208: The BMC 32 sends the request packet to the transferring device 12 via the network 50. In steps 206˜208, the server 14 requests the computer 15 what kind of Virtual USB storage is.
Step 210: The transferring device 12 responses a first response packet to the BMC 32 via the network 50.
Step 212: The BMC 32 sends the first response packet to the USB host 30. In step 210-212, under Virtual USB storage system, the transferring device 12 modifies the contents of descriptors from the first USB specification to the second USB specification. For example, the transferring device 12 modifies the contents of configuration descriptor and device descriptor from the USB 1.1 to USB 2.0.
Step 214: Determine whether initialization is done or not. If it is, go to Step 216; if not, go to Step 206.
Step 216: The USB host 30 generates a command packet to the BMC 32.
Step 218: The BMC 32 sends the command packet to the transferring device 12 via the network 50.
Step 220: The transferring device 12 responses a second request packet to the BMC 32 via the network 50.
Step 222: The BMC 32 sends the second request packet to the USB host 30.
Step 224: Determine whether the USB storage device is plugging-out. If it is, go to Step 228; if not, go to Step 226.
Step 226: The server 14 accesses data stored in the USB storage device with a speed complies with the second USB specification (such as USB 2.0). In step 226, the access speed of Virtual USB storage between computer 15 and server 14 is changed to the second USB specification. For example, the access speed of Virtual USB storage between computer 15 and server 14 is speeded up to USB 2.0.
Step 228: Stop

First of all, when a USB storage device 20 using USB 1.1 specification plugs into the transferring device 12, the transferring device 12 setups the USB storage device 20 (Step 200). Then, the transferring device 12 sends a connecting packet to the BMC 32 of the server 14 via the network 50, and then the BMC 32 receives the connecting packet and simulates the USB storage device 20 plugging-in signal to the USB host 30. Afterwards, the USB host 30 generates a request packet to the transferring device 12 through the BMC 32, indicative of confirming the reception of the connecting packet. In Step 210, when receiving the request packet, the transferring device 12 sends a first response packet to the BMC 32 via the network 50. It is noted that the first response packet comprises a device descriptor, and a configuration descriptor. Preferably, in spite of the USB storage device 20 using USB 1.1 specification, the transferring device 12 adjusts a value of a field bcdUSB in the device descriptor, which defines the USB version of the current USB storage device, as 0x0200 indicative of USB 2.0 specification, rather than 0x0110 indicative of USB 1.1 specification. Furthermore, the transferring device 12 configures a value of a bulk endpoint's field wMaxPacketSize in the configuration descriptor as 0x00 0x20 indicative of USB 2.0 specification, in lieu of 0x40 0x20 indicative of USB 1.1 specification. In another embodiment, in addition to adjustments of the field bcdUSB in the device descriptor and the bulk endpoint's field wMaxPacketSize in the configuration descriptor, the transferring device 12 may also alters a value of a field bMaxPacketSize in the device descriptor as 0x40 indicative of USB 2.0 specification, in lieu of 0x08 indicative of USB 1.1 specification. Upon receiving the first response packet, the USB host 30 sets the configuration based on the configuration data from the first response packet. Next, the server 14 determines whether initialization is done or not, if it is, go to Step 216; if not, go to Step 206.

After initialization is done, the USB host 30 generates a command packet to the BMC 32 and the BMC 32 sends the command packet to the transferring device 12 via the network 50. The transferring device 12 responses a second request packet to the BMC 32 via the network 50, and the BMC 32 sends the second request packet to the USB host 30. Since the value of the field bcdUSB in the device descriptor is set as 0x0200 indicative of USB 2.0 specification, and the value of the bulk endpoint's field wMaxPacketSize in the configuration descriptor is set as 0x00 0x20, the USB host 30 serves the USB storage device 20 plugging into the transferring device 12 as a USB device using USB 2.0 specification, and the server 14 accesses data stored in the USB storage device 20 with a speed complies with the USB 2.0 specification.

In contrast to prior art, the present invention discloses a transferring device capable of adjusting the field bcdUSB in the device descriptor defining the USB version of the current USB storage device as 0x0200 indicative of USB 2.0 specification, and a value of a bulk endpoint's field wMaxPacketSize in the configuration descriptor as 0x00 0x20 indicative of USB 2.0 specification, when a USB storage device electrically connected with the transferring device. Therefore, the server serves the USB storage device plugging into the transferring device as a USB device using USB 2.0 specification, and the server accesses data stored in the USB storage device with a speed complies with the USB 2.0 specification. In this way, through the transferring device, a conformity to the high speed newly defined of the USB 2.0 specification are variously designed to perform an faster data transfer speed.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A Universal Serial Bus (USB) transmission system, comprising:
a transferring device for outputting connecting packet when the transferring device is electrically connected to a USB storage device storing data in a first USB specification; and
a server for receiving the connecting packet and accordingly outputting a request packet to the transferring device;
wherein the transferring device receives the request packet and accordingly outputs a first response packet in indicative of a second USB specification to the server.

2. The system of claim 1, wherein the server outputs a command packet to the transferring device.

3. The system of claim 2, wherein the transferring device receives the command packet and accordingly outputs a second response packet to the server.

4. The system of claim 3, wherein the server accesses data in the USB storage device with the speed of the second USB specification.

5. The system of claim 1, wherein the server communicates with the transferring device via a network.

6. The system of claim 1, wherein the first USB specification complies with USB 1.1 specification, and the second USB specification complies with USB 2.0 specification.

7. The system of claim 1, wherein the first response packet indicates that a device descriptor and a configuration descriptor are modified to the second USB specification from the first USB specification.

8. The system of claim 7, wherein the USB version in the device descriptor is set as the second USB specification.

9. The system of claim 7, wherein the maximum packet size in the configuration descriptor is set as the speed of the second USB specification.

10. A method of transmitting data between a server and a Universal Serial Bus (USB) storage device storing data in a first USB specification via a transferring device, comprising:
outputting a connecting packet to the server by the transferring device when the USB storage device is electrically connected to the transferring device;
outputting a request packet to the transferring device by the server when the server receives the connecting packet; and
outputting a first response packet in indicative of a second USB specification to the server by the transferring device when the transferring device receives the request packet.

11. The method of claim 10, further comprising:
outputting a command packet to the transferring device by the server;
outputting a second response packet to the server by the transferring device when the transferring device receives the command packet; and
using speed of the second USB specification to access data in the USB storage device by the server.

12. The method of claim 10, wherein the first USB specification complies with USB 1.1 specification, and the second USB specification complies with USB 2.0 specification.

13. The method of claim 10, wherein the server communicates with the transferring device via a network.

14. The method of claim 10, wherein the first response packet indicates that a device descriptor and a configuration descriptor are modified to the second USB specification from the first USB specification.

15. The method of claim 14, wherein the USB version in the device descriptor is set as the second USB specification.

16. The method of claim 14, wherein the maximum packet size in the configuration descriptor is set as the speed of the second USB specification.

17. A method of transmitting data between a server and a Universal Serial Bus (USB) storage device storing data in a first USB specification via a computer with a transferring device, comprising:
detecting the USB storage device of a first USB specification by the computer when the USB storage device is plugged in the computer;
driving Virtual USB Storage function by the transferring device, and then detecting Virtual USB storage by the server;
requesting the computer what kind of Virtual USB storage is by the server;
modifying the contents of configuration descriptor and device descriptor from the first USB specification to a second USB specification; and
changing the access speed of Virtual Storage between the server and the computer to the second USB specification.

18. The method of claim 17, wherein the first USB specification complies with USB 1.1 specification, and the second USB specification complies with USB 2.0 specification.

19. The method of claim 17, wherein the server communicates with the transferring device via a network.

20. The method of claim 17, wherein the USB version in the device descriptor is set as the second USB specification, and the maximum packet size in the configuration descriptor is set as the speed of the second USB specification.
